(19) United States
(12) Patent Application Publication
(10) Pub. No.: US 2025/0078525 A1
(43) Pub. Date: Mar. 6, 2025

(54) INFORMATION PROCESSING DEVICE AND INFORMATION PROCESSING METHOD

(71) Applicant: Panasonic Automotive Systems Co., Ltd., Kanagawa (JP)

(72) Inventor: Satoshi FUKUMOTO, Tokyo (JP)

(21) Appl. No.: 18/732,316

(22) Filed: Jun. 3, 2024

(30) Foreign Application Priority Data
Aug. 29, 2023 (JP) 2023-138639

(51) Int. Cl. G06V 20/58; G01C 21/36; G06T 11/00

(52) U.S. Cl. CPC G06V 20/58; G01C 21/3602; G01C 21/3691; G06T 11/00

(57) ABSTRACT

An information processing device includes a processor and a memory having instructions that, when executed by the processor, cause the processor to perform operations including: acquire sensing information from an in-vehicle sensor mounted on a vehicle; detect an object around the vehicle based on the acquired sensing information; determine a display mode related to the detected object based on whether the detected object satisfies a condition accumulated in the memory; and output, to a display, information related to the detected object based on the display mode. When the detected object does not satisfy the condition, the display mode is a first mode, and the information related to the detected object does not include support information related to the detected object. When the detected object satisfies the condition, the display mode is a second mode, and the information related to the detected object includes the support information.

### CROSS-REFERENCE TO RELATED APPLICATIONS

This application is based upon and claims the benefit of priority from Japanese Patent Application No. 2023-138639, filed on Aug. 29, 2023, the entire contents of which are incorporated herein by reference.

### FIELD

Embodiments described herein relate generally to an information processing device and an information processing method.

### BACKGROUND

In an existing technology, there has been known a technique of attracting attention by superimposing and displaying support information related to an object, such as detected pedestrian, bicycle, automobile, and obstacle, on a display image or a field of view of a user to support driving of a moving body such as a vehicle. For example, JP 2012-257106 A discloses a technique of superimposing and displaying a substitute image corresponding to a detected three-dimensional object on a bird's-eye view image generated based on a shot image acquired by an in-vehicle camera that shoots a peripheral region of the vehicle.

However, when superimposing and displaying the information related to the detected object on the display image or the field of view of the user, visibility may be decreased, for example, the display image becomes difficult to see, the field of view of the user is blocked, or recognition is delayed due to unnecessary guidance of the line of sight.

One of problems to be solved by the present disclosure is to inhibit decrease in visibility due to superimposed display of information related to a detected object.

### SUMMARY

An information processing device according to an embodiment of the present disclosure includes a processor and a memory having instructions that, when executed by the processor, cause the processor to perform operations including: acquire sensing information from an in-vehicle sensor mounted on a vehicle; detect an object around the vehicle based on the acquired sensing information; determine a display mode related to the detected object based on whether the detected object satisfies a condition accumulated in the memory; and output, to a display, information related to the detected object based on the display mode. When the detected object does not satisfy the condition, the display mode is a first mode, and the information related to the detected object does not include support information related to the detected object. When the detected object satisfies the condition, the display mode is a second mode, and the information related to the detected object includes the support information.

### BRIEF DESCRIPTION OF THE DRAWINGS

FIG. 1 is a diagram schematically illustrating an example of a vehicle on which an information processing device according to an embodiment is mounted;

FIG. 2 is a block diagram illustrating an example of a hardware configuration of the information processing device according to the embodiment;

FIG. 3 is a block diagram illustrating an example of a functional configuration of the information processing device according to the embodiment;

FIG. 4 is a flowchart illustrating an example of a flow of information processing executed in the information processing device according to the embodiment;

FIG. 5 is a diagram illustrating an example of display of a detection result in a first mode in the information processing according to the embodiment; and

FIG. 6 is a diagram illustrating an example of display of a detection result in a second mode in the information processing according to the embodiment.

### DETAILED DESCRIPTION

Hereinafter, embodiments of an information processing device, a vehicle, an information processing system, an information processing method, a program, and a storage medium according to the present disclosure will be described with reference to the accompanying drawings.

In the description of the present disclosure, components having the same or substantially the same functions as those described above with respect to the previously described drawings are denoted by the same reference numerals, and the description thereof may be appropriately omitted. In addition, even in the case of representing the same or substantially the same portion, the dimensions and ratios may be represented differently from each other depending on the drawings. Furthermore, for example, from the viewpoint of ensuring visibility of the drawings, in the description of each drawing, main components are denoted by reference numerals, and even components having the same or substantially the same functions as those described above in the previous drawings may not be denoted by reference numerals.

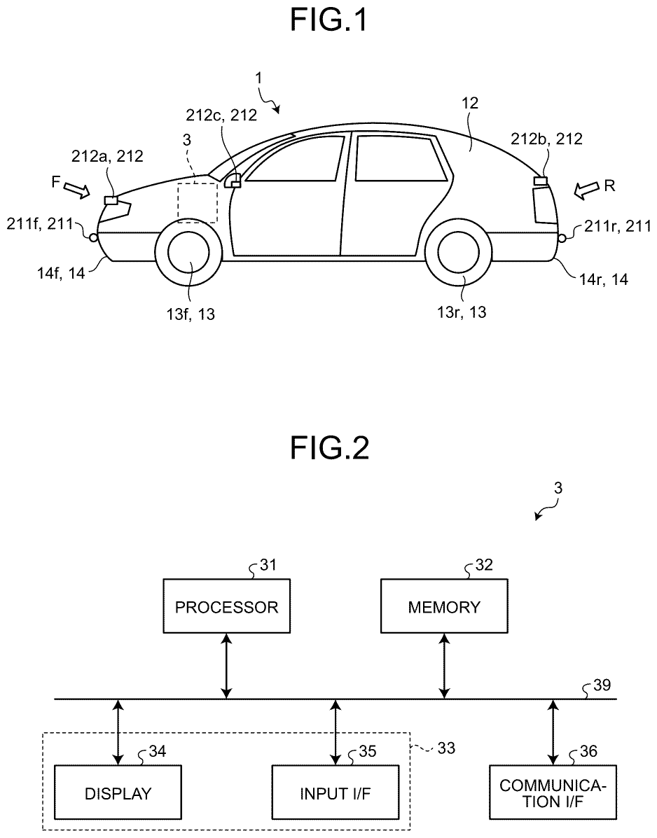

An information processing system according to the present disclosure includes a vehicle 1 and an information processing device 3. FIG. 1 is a diagram schematically illustrating an example of the vehicle 1 on which the information processing device 3 according to the embodiment is mounted.

Here, the vehicle 1 according to the embodiment is an example of a moving body. Note that, as the moving body according to the present disclosure, for example, various vehicles such as a wheelchair, a bicycle, an electric kickboard, an automobile, a motorcycle, and a railway vehicle can be appropriately used. In addition, the moving body 2 may be driven by any drive system. For example, the moving body 2 may be driven using a mounted battery, may be driven using an internal combustion engine, or may be driven by human power. Note that the technology according to the present disclosure is not limited to a vehicle and can be appropriately applied to various moving bodies such as a ship and an aircraft.

Note that, in the information processing system according to the present disclosure, a part of the processing of the information processing device 3 may be executed by a device outside the information processing device 3. For example, a part or all of the information processing device 3 may be provided outside the moving body. For example, the information processing system according to the present disclosure may be configured with the information processing device 3 provided outside the moving body so as to be able to communicate with the moving body, and the corresponding moving body. Alternatively, the information processing system according to the present disclosure may be configured with the information processing device 3 mounted on the moving body, the information processing device 3 provided outside the moving body so as to be able to communicate with at least one of the moving body and the in-vehicle information processing device 3, and the corresponding moving body.

As illustrated in FIG. 1, the vehicle 1 includes a vehicle body 12 and two pairs of wheels 13 arranged along a predetermined direction on the vehicle body 12. The two pairs of wheels 13 include a pair of front tires 13f and a pair of rear tires 13r.

FIG. 1 exemplifies the vehicle 1 having the four wheels 13, but the present disclosure is not limited thereto. The vehicle 1 may have at least one front tire 13f and at least one rear tire 13r. The number of wheels 13 of the vehicle 1 may be a plural number such as two, three, or five or more.

A direction of at least one wheel (steering wheel) of the wheels 13 of the vehicle 1 is electrically or mechanically interlocked with, for example, a rotation angle of a steering wheel disposed in front of a driver's seat of the vehicle 1, for example, a steering angle. Therefore, the vehicle 1 can turn right or left by steering. The steering wheel may be the rear tire 13r or may be both the front tire 13f and the rear tire 13r.

The vehicle body 12 is supported by the wheels 13. The vehicle 1 includes a driving machine (not illustrated) and is movable by driving at least one wheel (driving wheel) of the wheels 13 of the vehicle 1 by power of the driving machine. As the driving machine, any driving machine such as an engine using gasoline, hydrogen, or the like as a fuel, a motor using electric power from a battery, or a combination of an engine and a motor can be applied. In this case, a predetermined direction in which the two pairs of wheels 13 are arranged is a traveling direction of the vehicle 1. The vehicle 1 can move forward or backward by switching gears (not illustrated) or the like.

Also, the vehicle body 12 has a front end portion F that is an end portion near the front tire 13f and a rear end portion R that is an end portion near the rear tire 13r. The vehicle body 12 has a substantially rectangular shape in top view, and four corners of the substantially rectangular shape may be referred to as end portions.

A pair of bumpers 14 are provided near the lower end of the vehicle body 12 at the front and rear end portions F and R of the vehicle body 12. A front bumper 14f of the pair of bumpers 14 covers the entire front surface and a part of the side surface near the lower end portion of the vehicle body 12. A rear bumper 14r of the pair of bumpers 14 covers the entire rear surface and a part of the side surface near the lower end portion of the vehicle body 12.

The vehicle 1 includes at least one in-vehicle sensor. Each of the at least one in-vehicle sensor is connected to the information processing device 3 via an in-vehicle network including a controller area network (CAN), Ethernet (registered trademark), or the like.

FIG. 1 exemplifies a sonar (Sound Navigation And Ranging) 211 and an all-around camera 212 as in-vehicle sensors of the vehicle 1.

The sonar 211 is provided, for example, at a predetermined end portion of the vehicle body 12 and transmits and receives a sound wave such as an ultrasonic wave. The sonar 211 includes wave transmitting and receiving units 211f and 211r. For example, at least one wave transmitting and receiving unit 211f is disposed on the front bumper 14f, and at least one wave transmitting and receiving unit 211r is disposed on the rear bumper 14r. Furthermore, the number and/or positions of the wave transmitting and receiving units 211f and 211r are not limited to the example illustrated in FIG. 1 and can be changed as appropriate. For example, the vehicle 1 may include the wave transmitting and receiving units 211f and 211r on the left and right sides.

The sonar 211 detects an object around the vehicle 1 based on a transmission and reception result of a sound wave. The sonar 211 measures a distance between the object around the vehicle 1 and the vehicle 1 based on the transmission and reception result of a sound wave. Here, the object to be detected includes various three-dimensional objects referred to as obstacles such as a person (pedestrian), a bicycle, an automobile, and a structure.

In the present embodiment, the sonar 211 using a sound wave such as an ultrasonic wave is exemplified, but the present disclosure is not limited thereto. For example, the vehicle 1 may include, instead of the sonar 211 or in addition to the sonar 211, a Radio Detection and Ranging (RADAR) that transmits and receives radio waves or a Light Detection And Ranging (LiDAR) that transmits and receives laser light.

The all-around camera 212 is provided on the vehicle 1 so as to be able to shoot the surroundings of the vehicle 1. As an example, the vehicle 1 includes, as the all-around camera 212, a front camera 212a that shoots the front, a rear camera 212b that shoots the rear, a left-side camera 212c that shoots the left side, and a right-side camera that shoots the right side (not illustrated).

The all-around camera 212 shoots a video around the vehicle 1. The all-around camera 212 is, for example, a camera that shoots an image based on visible light and/or infrared light. Note that the image shot by the all-around camera 212 may be a moving image or a still image.

Note that, positions and/or the number of the all-around cameras 212 is not limited to the example illustrated in FIG. 1 and can be changed as appropriate. For example, the vehicle 1 may include two cameras: the front camera 212a and the rear camera 212b. Alternatively, the vehicle 1 may further include another camera in addition to the above-described example. For example, a part or all of the all-around cameras 212 may be provided in a vehicle interior space (inside the vehicle) of the vehicle 1. Also, the all-around camera 212 may be a camera built in the vehicle 1 or may be a camera of a drive recorder retrofitted to the vehicle 1, or the like.

The information processing device 3 is an example of an information processing device that can be mounted on the vehicle 1. The information processing device 3 is configured to be capable of executing information processing according to the embodiment, for example, based on sensing information from the in-vehicle sensor of the vehicle 1. The information processing device 3 is realized, for example, by at least one electronic control unit (ECU) or an on board unit (OBU) provided inside the vehicle 1.

Note that the information processing device 3 may be realized by a domain control unit (DCU) such as a Cockpit Domain Controller (CDC) in which a plurality of ECUs is integrated. The CDC is configured to be capable of executing processing such as in-vehicle infotainment (IVI), meter control, a display device control such as a head up display (HUD) and an electronic mirror, and advanced driver-assistance systems (ADAS). For example, the information processing device 3 may also serve as a car navigation device or the like. Alternatively, the information processing device 3 may be an external computer installed near the dashboard of the vehicle 1.

FIG. 2 is a diagram illustrating an example of a hardware configuration of the information processing device 3 according to the embodiment. As illustrated in FIG. 2, the information processing device 3 includes a processor 31, a memory 32, an HMI 33, and a communication interface (I/F) 36. The HMI 33 includes, for example, a display 34 and an input I/F 35. The processor 31, the memory 32, the display 34, the input I/F 35, and the communication I/F 36 are connected to each other by a bus 39 or the like and have a hardware configuration using a normal computer.

The processor 31 is an arithmetic device that controls the entire information processing device 3. The processor 31 loads a program stored in a read only memory (ROM), a hard disk drive (HDD), or the like of the memory 32 into a random access memory (RAN) of the memory 32 and executes the program, thereby realizing processing described below.

Note that, as the processor 31, various processors such as a central processing unit (CPU), a graphics processing unit (GPU), and a digital signal processor (DSP), a dedicated arithmetic circuit realized by an application specific integrated circuit (ASIC) and a field programmable gate array (FPGA), and the like can be used as appropriate.

The memory 32 includes, for example, a ROM that stores programs, parameters, and the like for realizing various processes by the processor 31. Furthermore, the memory 32 includes, for example, a RAM as a main storage device that temporarily stores data required for various processes by the processor 31. Note that the memory 32 may include various storage media and storage devices such as an HDD, a solid state drive (SSD), and a flash memory that store various types of data, programs, and the like used in each device of the information processing system 9.

The HMI 33 is an interface for outputting various types of information such as route guidance, notification, and warning to the driver of the vehicle 1. Also, the HMI 33 is an interface for receiving input of various types of information by the driver of the vehicle 1. Here, the HMI 33 according to the embodiment is an example of a display unit and an input unit. The HMI 33 may output various types of information recognizably by the driver of the vehicle 1 and may receive various operations of the driver of the vehicle 1. For example, the HMI 33 is provided around the driver's seat of the vehicle 1 but may be provided in another portion other than a portion around the driver's seat such as a rear seat.

As an example, the HMI 33 includes a display provided on a dashboard or a console of the vehicle 1 and configured to be able to output a video. The display is, for example, a liquid crystal display (LCD) or an organic electro luminescence (EL) display.

Note that the display may be configured as a touch panel display. Furthermore, the display may be a part of a car navigation device mounted on the vehicle 1.

Furthermore, the display may be a projection-type display device such as an HUD that projects a video (virtual image) in front of the driver, for example, in a display area provided on a windshield or a dashboard (console).

Furthermore, the display may be a display device that superimposes and displays support information related to a detected object on the field of view of the driver of the vehicle 1 by using a cross reality (XR) technology such as augmented reality (AR) glasses worn by the user. The display device is not limited to a glasses-type head mounted display (HMD) such as AR glasses, and a contact lens-type wearable device may be used. Further, this display device is not limited to using the AR technology, and various XR technologies such as VR (Virtual Reality), MR (Mixed Reality), and SR (Substitutional Reality) can be used.

As an example, the HMI 33 may be a display device that projects an image onto the retina. The display device includes, for example, a projection unit that emits laser light for representing an image and an optical system including a mirror that forms an image of the laser light from the projection unit on the retina. Alternatively, the display device includes, for example, an optical system including a half mirror and a projection unit that projects an image on the half mirror.

Note that the HMI 33 may include another output device such as a speaker configured to be capable of outputting a notification sound, a warning sound, or a voice.

As an example, the HMI 33 includes a touch panel of a touch panel display as an input device. The HMI 33 may include other input devices such as buttons, dials, switches, and microphones. These input devices are disposed, for example, on a dashboard, an instrument panel, a steering wheel, a console, or the like of the vehicle 1.

As the HMI 33, an operation terminal, such as a tablet terminal, a smartphone, a remote controller, or an electronic key, which can transmit or transmit and receive a signal from the outside of the vehicle 1 to the vehicle 1, may be used.

The communication I/F 36 is an interface for transmitting and receiving data to and from the outside of the information processing device 3. As an example, the communication I/F 36 receives data from another device provided on the vehicle 1, for example, an in-vehicle sensor. Note that the communication I/F 36 may transmit and receive information to and from another ECU mounted on the vehicle 1 via the in-vehicle network of the vehicle 1.

Note that the communication I/F 36 may communicate with an information processing device outside the vehicle 1 via a telecommunication line such as the Internet. For example, the communication I/F 36 may be configured to be able to transmit and receive a radio signal for transmitting information between the vehicle 1 and a radio base station. In this case, the communication I/F 36 is configured to be able to transmit and receive a radio signal between the vehicle 1 and the radio base station, for example, via an antenna (not illustrated) mounted on the vehicle 1. The radio signals are transmitted and received, for example, by any cellular V2X system such as mobile communication systems of each generation according to regulations of IMT 2020 such as 3G, LTE, 4G, and 5G or specifications of 3GPP (registered trademark), or a next-generation mobile communication system such as Beyond 5G (6G). The communication method related to transmission and reception of a radio signal may be, for example, other communication methods such as an IEEE-compliant DSRC method or a Vehicle-to-cellular-Network (V2N) method.

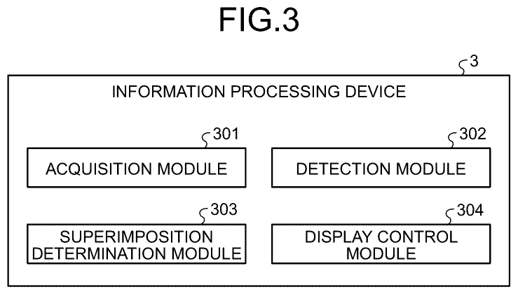

FIG. 3 is a diagram illustrating an example of a functional configuration of the information processing device 3 according to the embodiment. The information processing device 3 realizes functions, for example, as an acquisition module 301, a detection module 302, a superimposition determination module 303, and a display control module 304 by causing the processor 31 to execute a program loaded into the RAM of the memory 32.

The acquisition module 301 acquires sensing information from an in-vehicle sensor mounted on the vehicle, for example, via an I/F 45.

As an example, the acquisition module 301 acquires images and measurement results (sensing information) from the sonar 211, the all-around camera 212, the RADAR, the LiDAR, and the IMU, as an in-vehicle sensor.

The detection module 302 detects an object around the vehicle 1 based on the sensing information acquired by the acquisition module 301.

As an example, the detection module 302 detects an object included in an image (sensing information) obtained by capturing at least one of the front and the rear of the vehicle 1 by the all-around camera 212, for example, by using image processing such as edge detection or object recognition processing.

As an example, the detection module 302 detects an object existing in at least one of the front and the rear of the vehicle 1 based on a measurement result (sensing information) by the sonar 211, the RADAR, or the LiDAR with respect to at least one of the front and the rear of the vehicle 1.

The superimposition determination module 303 determines a display mode related to the detected object based on whether the object detected by the detection module 302 satisfies a predetermined condition related to visibility accumulated in the memory. For example, the superimposition determination module 303 determines whether an object is detected by the detection module 302. Furthermore, for example, the superimposition determination module 303 determines whether the detected object is difficult to see visually. Here, the superimposition determination module 303 according to the embodiment is an example of a determination module.

Note that the situation where the detected object is difficult to see visually in the present disclosure is a situation in which the visibility of the detected object on the display screen by the HMI 33 or the visibility in the field of view of the driver is low. Here, the situation where the detected object is difficult to see visually is an example of a case where a predetermined condition related to visibility is satisfied.

As an example, the situation where the detected object is difficult to see visually may be a case corresponding to time or a time zone that are determined in advance and stored in the memory 32 or the like, such as nighttime or twilight time periods before and after sunset. Note that the situation where the detected object is difficult to see visually may be a case not corresponding to time or a time zone that is determined in advance and stored in the memory 32 or the like such as daytime.

As an example, the situation where the detected object is difficult to see visually may be a case where the illuminance around the detected object at nighttime, in a tunnel, or the like, or the illuminance around the vehicle 1 deviates from a threshold range such as smaller than a threshold that is determined in advance and stored in the memory 32 or the like.

As an example, the situation where the detected object is difficult to see visually may be a case where the contrast difference between the detected object and the background of the corresponding object on the image or in the field of view of the driver deviates from a threshold range such as smaller than a threshold that is determined in advance and stored in the memory 32 or the like, for example, a case where a person as the detected object in gray clothes is in front of concrete, or the like. Note that the contrast difference may be calculated by using a value related to colors such as brightness, saturation, and hue, or may be calculated by using a luminance value on an image.

As an example, the situation where the detected object is difficult to see visually may be a case where the detected object is out of sight in the image or in the field of view of the driver. Note that the case where the detected object is out of sight may be a case where the entire detected object or a portion equal to or larger than a ratio that is determined in advance and stored in the memory 32 or the like is not within the angle of view of the all-around camera 212 or the field of view of the driver or is hidden by another object such as an obstacle.

As an example, the situation where the detected object is difficult to see visually may be a case where distortion on the image of the detected object is larger than a threshold that is determined in advance and stored in the memory 32 or the like or deviates from the range when the processing of combining two or more images obtained by the all-around camera 212 is executed or when the viewpoint transformation processing is executed on one or more images obtained by the all-around camera 212.

In addition, when the detected object is in a situation of not being difficult to see visually, for example, when the predetermined condition related to visibility is not satisfied, the superimposition determination module 303 determines the first mode of superimposing and displaying the detection information indicating the detection result for the detected object as the display mode by the HMI 33. In the first mode, the information related to the detected object does not include support information related to the detected object.

Note that the display in the first mode may be a simpler drawing than the display in the second mode described below and is not limited to a mode of displaying information indicating a detection result for each detected object. The simple drawing may be expressed as a simple display and means that the area of the display to be superimposed on the image or the field of view of the driver or the number thereof is small. In the display according to the first mode, each display of the information indicating the detection result may be displayed at a position not related to the position of the detected object.

As an example, the detection information indicating the detection result is a detection frame indicating a detected object. Note that the detection information may be, instead of or in addition to the detection frame, a frame that highlights the image or the entire field of view of the driver, an icon and/or text indicating that an object is detected, or a combination thereof.

In addition, when the detected object is difficult to see visually, for example, when the predetermined condition related to visibility is satisfied, the superimposition determination module 303 determines a second mode of superimposing and displaying a pictogram indicating the type of the detected object at a position corresponding to the detected object together with detection information such as a detection frame as the display mode of the detection result by the HMI 33. Here, the pictogram indicating the type of the detected object is an example of the support information. In the second mode, the information related to the detected object includes the support information related to the detected object.

Note that the support information to be superimposed and displayed on the detected object in the second mode is not limited to the pictogram. For example, in the second mode, the silhouette of the detected object may be superimposed and displayed as the support information.

In the second mode, the color, the size, and the direction of the detected object may be reflected in the pictogram. For example, the pictogram may be displayed in a color corresponding to the color of the detected object. For example, when the detected object is a person, the pictogram to be displayed may be different depending on whether the detected object is a child or an adult. For example, when the detected object is a vehicle, the pictogram may be different between the truck and the passenger vehicle. For example, the pictogram may be prepared for each classification more detailed than the classification.

In the second mode, a pictogram common to a plurality of types may be used as the pictogram. For example, the pictogram may not necessarily be prepared for each type of the object, for example, the pictogram is prepared for each classification larger than the type.

In addition, the size of the pictogram displayed in a superimposed manner in the second mode may be determined according to the distance from the vehicle 1. The size of the pictogram decreases, for example, as the distance from the vehicle 1 increases. For example, the size of the pictogram may be determined to a size the detected object in the image or the field of view of the driver. For example, when the detected object is out of sight, the entire pictogram may be superimposed and displayed with a size determined based on the distance to the detected object.

Further, the position of the pictogram superimposed and displayed in the second mode in the image or the field of view of the driver may be adjusted according to the reference position of the detected object. For example, when the detected object is a person, the position at which the pictogram is superimposed and displayed may be adjusted depending on the foot position of the detected person. For example, when the detected object is a vehicle, the position at which the pictogram is superimposed and displayed may be adjusted depending on the tire position of the detected vehicle. Meanwhile, for example, when the reference position of the detected object such as the foot position of the detected person or the tire position of the detected vehicle is out of sight, the position where the pictogram is superimposed and displayed may not be adjusted.

In addition, in the second mode, when any of the plurality of detected objects is difficult to see visually, the pictogram may be superimposed and displayed for the object in a situation of being difficult to see visually. Meanwhile, when any of the plurality of detected objects is difficult to see visually, the pictogram may be superimposed and displayed for the other detected objects regardless of whether the objects are in a situation of being difficult to see visually.

In addition, the position of the pictogram superimposed and displayed in the second mode in the image or the field of view of the driver may be adjusted to be shifted in the left-right direction, for example, in order to ensure the visibility of the detected object. As an example, in a situation where the detected object is easily visible, such as in a bright state, the pictogram may be superimposed and displayed at a position laterally shifted from the position of the detected object.

The display control module 304 controls display by the HMI 33. For example, the display control module 304 causes the HMI 33 to display information on the detected object in the display mode determined by the superimposition determination module 303. Specifically, the display control module 304 generates display information for displaying information on the detected object in the display mode determined by the superimposition determination module 303 and outputs the generated display information to the HMI 33.

As an example, the display control module 304 displays the detection result in the first mode by the HMI 33 when the detected object is not in a situation of being difficult to see visually.

As an example, the display control module 304 displays the detection result in the second mode by the HMI 33 when the detected object is difficult to see visually.

Note that the detection module 302 and the superimposition determination module 303 may be realized as one function.

Next, a flow of information processing executed by the information processing system configured as described above is described. Note that the flow of processing described below is an example, and it is also possible to change the processing order, delete some processing, and add other processing.

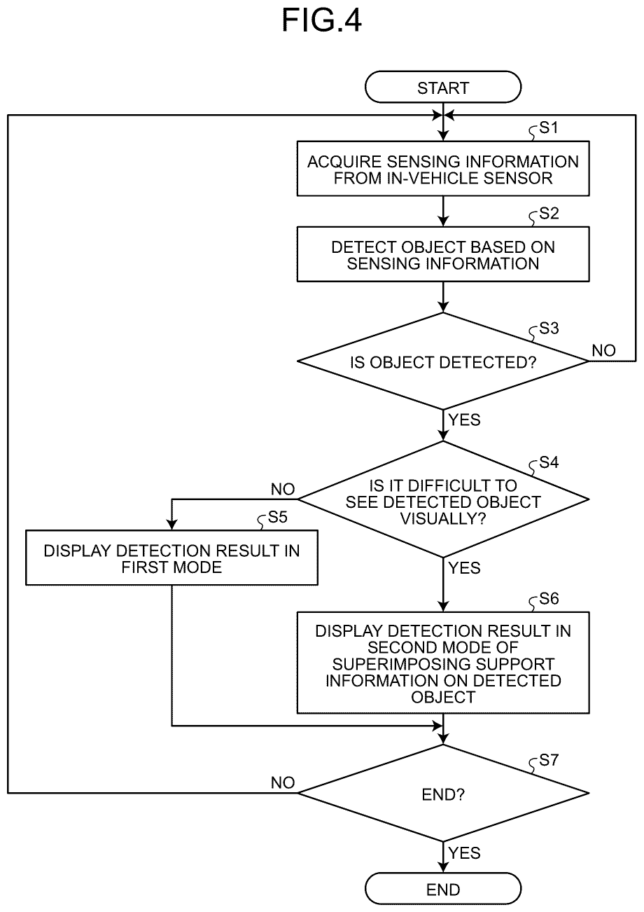

FIG. 4 is a flowchart illustrating an example of a flow of information processing executed in the information processing device 3 according to the embodiment.

The acquisition module 301 acquires sensor data (sensing information) from the in-vehicle sensor, for example, via the communication I/F 36 (S1). Then, the detection module 302 executes object detection based on the sensing information (S2).

The superimposition determination module 303 determines whether an object is detected (S3). When an object is not detected (S3: No), the flow of FIG. 4 returns to the processing of S1. Meanwhile, when an object is detected (S3: Yes), the superimposition determination module 303 determines whether the detected object is difficult to see visually (S4).

When the detected object is not in a situation of being difficult to see visually (S4: No), the superimposition determination module 303 determines the display mode of the detection result by the HMI 33 as the first mode in which the detection information is superimposed and displayed. Then, the display control module 304 displays the detection result in the first mode by the HMI 33 (S5).

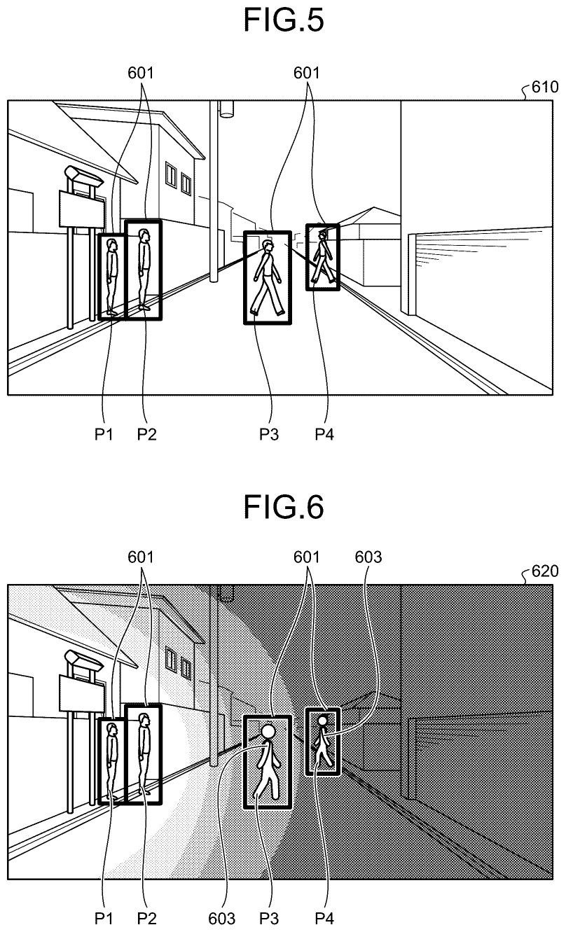

FIG. 5 is a diagram illustrating an example of display of the detection result in the first mode in the information processing according to the embodiment.

As an example, the display control module 304 causes the HMI 33 to display a display screen 610 on which detection frames 601 respectively indicating persons P1 to P4 as the detected objects are superimposed and displayed on the image acquired by the acquisition module 301.

As an example, the display control module 304 superimposes the detection frames 601 on the positions respectively corresponding to the persons P1 to P4 as the detected objects with respect to the field of view of the driver and displays the detection frames 601 by the HMI 33. As a result, a field of view similar to that of the driver who visually recognizes the display screen 610 is provided to the driver.

As described above, when the detected object is not in a situation of being difficult to see visually, the superimposition determination module 303 determines not to superimpose the support information on the detected object.

Meanwhile, when the detected object is difficult to see visually (S4: Yes), the superimposition determination module 303 determines the display mode of the detection result by the HMI 33 as the second mode of superimposing and displaying the support information on the detected object in addition to the detection information. Then, the display control module 304 displays the detection result in the second mode by the HMI 33 (S6).

FIG. 6 is a diagram illustrating an example of the display of the detection result in the second mode in the information processing according to the embodiment.

As an example, the display control module 304 causes the HMI 33 to display, on the image acquired by the acquisition module 301, a display screen 620 on which the support information is superimposed and displayed for each of the persons P3 and P4 determined to be in a situation of being difficult to see visually, together with the detection frame 601 respectively indicating the persons P1 to P4. FIG. 6 illustrates a pictogram 603 indicating the type of the object as the support information.

For example, in the example of FIG. 6, depending on the distance from the vehicle 1, the pictogram of the distant person P4 is small, and the pictogram 603 of the near person P3 is largely superimposed and displayed. For example, in the example of FIG. 6, the pictogram 603 reflecting the direction of the detected person is superimposed and displayed. Note that, in the example of FIG. 6, when the persons P3 and P4 determined to be in a situation of being difficult to see visually are detected, the pictogram may be superimposed and displayed on the other detected persons P1 and P2.

As an example, the display control module 304 superimposes the support information on each of the persons P3 and P4 determined to be in a situation of being difficult to see visually together with the detection frames 601 respectively indicating the detected persons P1 to P4 with respect to the field of view of the driver and displays the superimposed support information by the HMI 33. As a result, a field of view similar to that of the driver who visually recognizes the display screen 620 is provided to the driver.

As described above, when the detected object is difficult to see visually, the superimposition determination module 303 determines that the support information is superimposed on the detected object.

Thereafter, when it is not determined to end the flow of FIG. 4 (S7: No), the flow returns to the processing of S1. Meanwhile, when it is determined to end (S7: Yes), the flow of FIG. 4 ends.

As described above, the information processing device 3 according to the embodiment is configured to superimpose and display detection information indicating a detection result of an object such as a person or an obstacle in a first mode in which frame display or the like is simple in a situation where the detected object is easily visible, such as in the daytime. In addition, at nighttime or when the contrast difference from the background is small, in a situation where the detected object is difficult to see visually such as a case where the detected object is out of sight, the information processing device 3 is configured to superimpose and display a pictogram indicating the type together with the detection information.

According to this configuration, in a situation where the detected object is difficult to see visually, it is possible to enable the user to easily recognize the detected object by displaying the support information. Furthermore, according to the above configuration, by reducing the drawing of the support information in a situation where the detected object is easily visible, it is possible to inhibit the difficulty of the user recognizing the detected object by the display, such as a case where the display of the information related to the detected object hinders the visual observation of the detected object or the field of view. Therefore, according to the technology according to the embodiment, action support and driving support such as appropriate attention calling and information provision to the user can be realized to inhibit occurrence of an accident, thereby enhancing convenience of the user.

Note that, in the information processing according to the embodiment described above, the sensor data (sensing information) from the in-vehicle sensor may be at least any one of data of an image obtained by the all-around camera 212 and data of a measurement result obtained by the sonar 211. For example, the object may be detected by using at least any one of an image and a measurement result. For example, the determination as to whether the detected object satisfies the predetermined condition related to the visibility may be performed by using at least any one of the image and the measurement result.

Note that the vehicle 1 may be equipped with various sensors (not illustrated).

As an example, the vehicle 1 may include an illuminance sensor. In this case, the information processing device 3 may acquire data of the measurement result from the illuminance sensor as the sensing information. For example, the transmittance of the pictogram superimposed and displayed in the second mode may be changed according to the illuminance around the detected object or the vehicle 1. The transmittance of the pictogram is smaller, for example, as the illuminance is lower. For example, in a dark case, the transmittance of the pictogram can be lowered to cause the display of the pictogram stand out. Meanwhile, for example, in a bright case, the transmittance of the pictogram can be increased so as not to hinder the image or the field of view of the driver. In addition, for example, whether to adjust the position of the pictogram superimposed and displayed in the second mode in the image or the field of view of the driver to be shifted in the left-right direction according to the illuminance of the detected object may be determined. For example, in a dark case or the like, in a situation where the detected object is difficult to see visually, the position of the pictogram may not be adjusted to be shifted laterally from the position of the detected object.

As an example, the vehicle 1 may include a raindrop sensor or a sensor that acquires a wiper operation. In this case, the information processing device 3 may acquire data of a measurement result from the raindrop sensor or the sensor that acquires a wiper operation as sensing information related to the weather. For example, whether the detected object satisfies a predetermined condition related to visibility may be determined by using sensing information related to weather. As an example, the situation where the detected object is difficult to see visually may be a case corresponding to the weather that is determined in advance and stored in the memory 32 or the like, such as rainy weather or cloudy weather. Note that the situation where the detected object is difficult to see visually may be a case not corresponding to the weather that is determined in advance and stored in the memory 32 or the like such as fine weather. Note that the information processing device 3 may acquire information related to weather on the Internet, for example, by communication with the outside of the vehicle 1 via the communication I/F 36 and determine whether a predetermined condition related to visibility is satisfied based on the acquired information related to the weather.

As an example, the in-vehicle sensor of the vehicle 1 includes a steering angle sensor that outputs a signal in accordance with the operation amount of the steering wheel by the driver, for example, the steering angle. As an example, the in-vehicle sensor of the vehicle 1 includes a wheel speed sensor that outputs a signal in accordance with the rotation speed and the rotation direction of the wheel 13. As an example, the in-vehicle sensor of the vehicle 1 includes a brake sensor that detects the operation amount of the brake pedal by the driver. As an example, the in-vehicle sensor of the vehicle 1 includes an accelerator sensor that detects the operation amount of an accelerator pedal by a driver. As an example, the in-vehicle sensor of the vehicle 1 includes an acceleration sensor that outputs a signal in accordance with acceleration applied to the vehicle 1. As an example, the in-vehicle sensor of the vehicle 1 includes a gyro sensor that outputs a signal in accordance with an angular velocity applied to the vehicle 1. The acceleration sensor and the gyro sensor may be provided, for example, in three axes and configured as an inertial measurement unit (IMU). As an example, the in-vehicle sensor of the vehicle 1 includes a global navigation satellite system (GNSS) sensor that outputs position information of the vehicle 1, such as a global positioning system (GPS) sensor. Note that the GNSS sensor includes a GNSS antenna that receives radio waves from a satellite, and a GNSS circuit that obtains position information based on radio waves from at least two satellites received by the GNSS antenna.

Note that, in the embodiment described above, the situation where the detected object is difficult to see visually is exemplified as a case where the predetermined condition related to visibility is satisfied, but the present disclosure is not limited thereto. For example, the case where the predetermined condition related to visibility is satisfied may be a situation where the degree of urgency related to the detected object is high.

As an example, the situation where the degree of urgency related to the detected object is high may be a case where the distance to the detected object is equal to or less than a predetermined distance that is determined in advance and stored in the memory 32 or the like.

As an example, the situation where the degree of urgency related to the detected object is high may be a case where an object is detected behind the vehicle 1 when the vehicle 1 travels backward.

As an example, the situation where the degree of urgency related to the detected object is high may be a case where the evaluation value of the collision risk such as time-to-collision (TTC) with the detected object deviates from the threshold range, such as smaller than a threshold that is determined in advance and stored in the memory 32 or the like.

As an example, the situation in which the degree of urgency related to the detected object is high may be a case where the detected object is included in an area that cannot be seen by the driver of the vehicle 1.

Note that, in the embodiment described above, the case of using the sensing information from the in-vehicle sensor of the vehicle 1 is exemplified, but the present disclosure is not limited thereto. The sensing information may be information, for example, from an external camera or a measurement sensor such as an AR glass mounted to the head, the chest, or the like of the user.

Note that some or all of the in-vehicle sensors described above may be included in the information processing device 3. Meanwhile, a part or all of the HMI 33 described above may not be included in the information processing device 3.

Note that, in the embodiment described above, a case where the user of the information processing device 3 is a driver who moves by a moving body such as the vehicle 1 is exemplified, but the present disclosure is not limited thereto. The user of the information processing device 3 is not limited to the driver of the moving body, may be a passenger of the moving body, or may be a pedestrian who is not using the moving body. In other words, the information processing system according to the present embodiment may be a system that executes driving assistance of a moving body or a system that executes action assistance of a pedestrian. For example, the information processing device 3 according to the embodiment may be configured as a device that outputs display information to a display terminal such as an AR glass worn by a pedestrian or a smartphone held by the pedestrian.

Note that, in the above embodiment, mainly a case where the detection information and the support information are superimposed on the front image obtained by capturing the front of the vehicle 1, the rear image obtained by capturing the rear of the vehicle 1, and the image obtained by combining the plurality of images obtained by capturing the surroundings of the vehicle 1 including the front or the rear is exemplified. However, the present disclosure is not limited thereto. The image on which the detection information and the support information are superimposed may be a top view (overhead image) obtained by combining a plurality of images obtained by capturing the surroundings of the vehicle 1.

Note that, in each of the embodiments described above, “determining whether it is A” may be determining that it is A, may be determining that it is not A, or may be determining whether it is A.

Each program executed by each device of the information processing system according to each embodiment described above is provided by being recorded in a computer-readable storage medium such as a CD-ROM, an FD, a CD-R, or a DVD as a file in an installable format or an executable format.

Furthermore, each program executed by each device of the information processing system according to each embodiment described above may be stored on a computer connected to a network such as the Internet and provided by being downloaded via the network. Furthermore, each program executed by each device of the information processing system according to each embodiment described above may be configured to be provided or distributed via a network such as the Internet.

Furthermore, each program executed by each device of the information processing system according to each embodiment described above may be configured to be provided by being incorporated in a ROM or the like in advance.

Furthermore, the program executed by each device of the information processing system according to each embodiment described above is modularly configured to include each functional units described above, and as actual hardware, the processor 31 such as a CPU reads the program from the memory 32 such as a ROM or an HDD and executes the program, whereby each functional unit is loaded onto the RAM of the memory 32, and each functional unit is generated on the RAM of the memory 32.

According to at least one embodiment described above, it is possible to inhibit a decrease in visibility due to superimposed display of information related to the detected object.

According to the present disclosure, it is possible to inhibit decrease in visibility due to superimposed display of information related to the detected object.

While certain embodiments have been described, these embodiments have been presented by way of example only, and are not intended to limit the scope of the disclosures. Indeed, the novel methods and systems described herein may be embodied in a variety of other forms; furthermore, various omissions, substitutions and changes in the form of the methods and systems described herein may be made without departing from the spirit of the disclosures. The accompanying claims and their equivalents are intended to cover such forms or modifications as would fall within the scope and spirit of the disclosures.

### Supplementary Note

The following technique is disclosed by the above description of the embodiments.
(1) An information processing device includes a processor and a memory having instructions that, when executed by the processor, cause the processor to perform operations including: acquire sensing information from an in-vehicle sensor mounted on a vehicle; detect an object around the vehicle based on the acquired sensing information; determine a display mode related to the detected object based on whether the detected object satisfies a condition accumulated in the memory; and output, to a display, information related to the detected object based on the display mode. When the detected object does not satisfy the condition, the display mode is a first mode, and the information related to the detected object does not include support information related to the detected object, and when the detected object satisfies the condition, the display mode is a second mode, and the information related to the detected object includes the support information.
(2) In the information processing device according to (1), the information related to the detected object includes detection information related to the detected object.
(3) In the information processing device according to (1), the sensing information includes at least one of an image obtained by capturing surroundings of the vehicle and a measurement result obtained by measuring the surroundings of the vehicle.
(4) In the information processing device according to (1), a case where the condition is satisfied includes at least one of a situation where the detected object is difficult to see visually or a situation where a degree of urgency related to the detected object is high.
(5) In the information processing device according to (4), the situation where the detected object is difficult to see visually includes a case where a time when the object is detected corresponds to a determined time or a determined time zone.
(6) In the information processing device according to (4), the situation where the detected object is difficult to see visually includes a case where an illuminance around the detected object or the vehicle deviates from a determined threshold range.
(7) In the information processing device according to (4), the situation where the detected object is difficult to see visually includes a case where a contrast difference between the detected object and a background of the object deviates from a determined threshold range.
(8) In the information processing device according to (4), the situation where the detected object is difficult to see visually includes a case where the detected object is out of sight.
(9) In the information processing device according to (4), the situation where the detected object is difficult to see visually includes a case corresponding to determined weather.
(10) In the information processing device according to any one of (2) to (9), the detection information includes a detection frame indicating the detected object.
(11) In the information processing device according to any one of (1) to (10), the support information includes a pictogram indicating a type of the detected object or a silhouette of the detected object.
(12) In the information processing device according to any one of (1) to (11), the processor, in operation, further outputs, to the display, an image obtained by capturing surroundings of the vehicle, and the display superimposes and displays the image and the information related to the detected object.
(13) An information processing method includes: acquiring sensing information from an in-vehicle sensor mounted on a vehicle; detecting an object around the vehicle based on the acquired sensing information; determining a display mode related to the detected object based on whether the detected object satisfies a condition accumulated in a memory; and outputting, to a display, information related to the detected object based on the display mode. When the detected object does not satisfy the condition, the display mode is a first mode, and the information related to the detected object does not include support information related to the detected object, and when the detected object satisfies the condition, the display mode is a second mode, and the information related to the detected object includes the support information.
(14) In the information processing method according to (13), the information related to the detected object includes detection information related to the detected object.
(15) In the information processing method according to (13), the sensing information includes at least one of an image obtained by capturing surroundings of the vehicle and a measurement result obtained by measuring the surroundings of the vehicle.
(16) In the information processing method according to (13), a case where the condition is satisfied includes at least one of a situation where the detected object is difficult to see visually or a situation where a degree of urgency related to the detected object is high.
(17) In the information processing method according to (15), the situation where the detected object is difficult to see visually includes a case where a time when the object is detected corresponds to a determined time or a determined time zone.
(18) In the information processing method according to (15), the situation where the detected object is difficult to see visually includes a case where an illuminance around the detected object or the vehicle deviates from a determined threshold range.
(19) In the information processing method according to (15), the situation where the detected object is difficult to see visually includes a case where a contrast difference between the detected object and a background of the object deviates from a determined threshold range.
(20) In the information processing method according to (15), the situation where the detected object is difficult to see visually includes a case where the detected object is out of sight.

What is claimed is:

1. An information processing device comprising:
a processor; and
a memory having instructions that, when executed by the processor, cause the processor to perform operations comprising:
acquire sensing information from an in-vehicle sensor mounted on a vehicle;
detect an object around the vehicle based on the acquired sensing information;
determine a display mode related to the detected object based on whether the detected object satisfies a condition accumulated in the memory; and
output, to a display, information related to the detected object based on the display mode, wherein
when the detected object does not satisfy the condition, the display mode is a first mode, and the information related to the detected object does not include support information related to the detected object, and
when the detected object satisfies the condition, the display mode is a second mode, and the information related to the detected object includes the support information.

2. The information processing device according to claim 1, wherein
the information related to the detected object includes detection information related to the detected object.

3. The information processing device according to claim 1, wherein
the sensing information includes at least one of an image obtained by capturing surroundings of the vehicle and a measurement result obtained by measuring the surroundings of the vehicle.

4. The information processing device according to claim 1, wherein
a case where the condition is satisfied includes at least one of a situation where the detected object is difficult to see visually or a situation where a degree of urgency related to the detected object is high.

5. The information processing device according to claim 4, wherein
the situation where the detected object is difficult to see visually includes a case where a time when the object is detected corresponds to a determined time or a determined time zone.

6. The information processing device according to claim 4, wherein
the situation where the detected object is difficult to see visually includes a case where an illuminance around the detected object or the vehicle deviates from a determined threshold range.

7. The information processing device according to claim 4, wherein
the situation where the detected object is difficult to see visually includes a case where a contrast difference between the detected object and a background of the object deviates from a determined threshold range.

8. The information processing device according to claim 4, wherein
the situation where the detected object is difficult to see visually includes a case where the detected object is out of sight.

9. The information processing device according to claim 4, wherein
the situation where the detected object is difficult to see visually includes a case corresponding to determined weather.

10. The information processing device according to claim 2, wherein
the detection information includes a detection frame indicating the detected object.

11. The information processing device according to claim 1, wherein
the support information includes a pictogram indicating a type of the detected object or a silhouette of the detected object.

12. The information processing device according to claim 1, wherein
the processor, in operation, further outputs, to the display, an image obtained by capturing surroundings of the vehicle, and
the display superimposes and displays the image and the information related to the detected object.

13. An information processing method comprising:
acquiring sensing information from an in-vehicle sensor mounted on a vehicle;
detecting an object around the vehicle based on the acquired sensing information;
determining a display mode related to the detected object based on whether the detected object satisfies a condition accumulated in a memory; and
outputting, to a display, information related to the detected object based on the display mode, wherein
when the detected object does not satisfy the condition, the display mode is a first mode, and the information related to the detected object does not include support information related to the detected object, and
when the detected object satisfies the condition, the display mode is a second mode, and the information related to the detected object includes the support information.

14. The information processing method according to claim 13, wherein
the information related to the detected object includes detection information related to the detected object.

15. The information processing method according to claim 13, wherein
the sensing information includes at least one of an image obtained by capturing surroundings of the vehicle and a measurement result obtained by measuring the surroundings of the vehicle.

16. The information processing method according to claim 13, wherein
a case where the condition is satisfied includes at least one of a situation where the detected object is difficult to see visually or a situation where a degree of urgency related to the detected object is high.

17. The information processing method according to claim 15, wherein
the situation where the detected object is difficult to see visually includes a case where a time when the object is detected corresponds to a determined time or a determined time zone.

18. The information processing method according to claim 15, wherein
the situation where the detected object is difficult to see visually includes a case where an illuminance around the detected object or the vehicle deviates from a determined threshold range.

19. The information processing method according to claim 15, wherein
the situation where the detected object is difficult to see visually includes a case where a contrast difference between the detected object and a background of the object deviates from a determined threshold range.

20. The information processing method according to claim 15 wherein
the situation where the detected object is difficult to see visually includes a case where the detected object is out of sight.
